(19) United States
(12) Patent Application Publication
(10) Pub. No.: US 2010/0209820 A1
(43) Pub. Date: Aug. 19, 2010

(54) FUEL CELL

(76) Inventors: Taner Akbay, Ibaraki (JP); Takashi Miyazawa, Ibaraki (JP); Naoya Murakami, Ibaraki (JP); Tadahiko Suzuki, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/532,883

(22) PCT Filed: Mar. 13, 2008
(86) PCT No.: PCT/JP2008/000568

§ 371 Date: Apr. 1, 2010

(30) Foreign Application Priority Data
Mar. 29, 2007 (JP) 2007-088403

(51) Int. Cl. H01M 8/02

(52) U.S. Cl. 429/514

(57) ABSTRACT

A fuel cell in which fuel gas is more uniformly distributed to each power generation cell and irregular deformation of an interconnection section is reduced. A fuel gas channel (17) formed in a fuel arm section (22) of a separator (19) has a smaller cross-sectional area than an oxidation agent gas channel (18) formed in an oxidation agent arm section (21). Further, the fuel arm section (22) and the oxidation agent arm section (21) are formed so that their section moduli are substantially the same.

### TECHNICAL FIELD

The present invention relates to a flat plate laminated type fuel cell constructed by laminating power generation cells and separators which are arranged on both surfaces of each of the power generation cells through a fuel electrode current collector or an air electrode current collector.

### BACKGROUND ART

In these years, a fuel cell has drawn attention as a clean and highly efficient power generating device. Particularly, research and development on a solid oxide fuel cell as the third-generation power generation fuel cell is ongoing.

The solid oxide fuel cell is configured such that a plurality of unit cells are laminated in layers, wherein the unit cell includes a power generation cell having a fuel electrode layer and an oxidant electrode layer formed respectively on both surfaces of an oxide ion conductor; a fuel electrode current collector and an oxidant electrode current collector provided to sandwich the power generation cell therebetween; and a separator provided outside the fuel electrode current collector and the oxidant electrode current collector.

Here, the separator has a function of electrically connecting the power generation cells to each other and of supplying the reactant gas to the power generation cells. The separator includes thereinside a fuel gas channel which introduces a fuel gas to the fuel electrode layer side and an oxidant gas channel which introduces an oxidant gas to the air electrode layer side.

In the solid oxide fuel cell, the fuel gas (H₂, CO, and the like) is supplied to the fuel electrode layer side and the oxidant gas (O₂) is supplied to the oxidant electrode layer side respectively as a reactant gas from the fuel gas channel and the oxidant gas channel of the separator.

In the power generation cell, the oxygen gas supplied to the oxidant electrode layer side reaches near the boundary with the solid electrolyte layer through pores in the oxidant electrode current collector, and there, receives electrons to be ionized into oxide ions (O²⁻). Then, the oxide ions diffusively move in the solid electrolyte layer toward the fuel electrode layer and reach near the boundary with the fuel electrode layer, where the oxide ions react with the fuel gas to produce a reaction product (H₂O, CO₂, and the like) and emits electrons to the fuel electrode layer. The electrons can be taken as an electromotive force by an external load.

Here, in the flat plate laminated type of solid oxide fuel cell, a load is applied to the separators located at both ends of the laminated body (stack) in the lamination direction so that the individual components of the laminated body are pressure-bonded and closely appressed to each other.

The fuel electrode current collector and the oxidant electrode current collector are made of, for example, a sponge-like porous metal plate since they require a current collecting function, a gas transport function and a uniform gas diffusion function for making the reactant gas diffuse and reach uniformly to the boundary surface with the solid electrolyte layer, and the like.

In the solid oxide fuel cell configured as above, in order to allow a power generation reaction to be performed stably and continuously in the laminated body, it is very important to uniformly supply the reactant gases (uniform supply), particularly the fuel gas directly affecting the power generation reaction, to each of the many laminated power generation cells.

In order to achieve the uniform supply of the fuel gas, it is necessary to improve the gas flow distribution performance by adjusting the channel pressure drop (pressure loss) in the fuel electrode current collector and the pressure drop (pressure loss) in the fuel gas channel formed in the separator.

However, as described above, the fuel electrode current collector is made of a sponge-like porous metal body having not only the current collecting function but also the fuel gas transport function, the uniform gas diffusion function, a cushion function, and the like. Therefore, a variation occurs in the channel pressure drop depending on the variation of the void ratio and the internal framework structure of the fuel electrode current collector, and the like. For reference sake, currently, lot-to-lot variation of the pressure drop in the fuel electrode current collectors is very large amounting to about 15%.

The individual fuel electrode current collectors differ in channel pressure drop, which produces an uneven flow distribution of fuel gases introduced from the manifold into the individual power generation cells. As a result, voltage drops in the power generation cells which fall short of fuel gas supply (large channel pressure drop). Accordingly, the stack where the power generation cells are connected in series has a problem in that cell performance declines as a whole.

The present inventors have found that, in terms of the structure of the fuel electrode current collector, the variation of the channel pressure drop in the current collector is more significant than the pressure drop in the fuel gas channel of the separator, and thus the variation of the current collector channel pressure drop greatly affects the variation of the total pressure drop caused by the separator channel pressure drop and the current collector channel pressure drop. In the following Patent Document 1, based on the above finding, the present inventors have proposed a solid oxide fuel cell which provides a gas flow restricting mechanism such as an orifice between a fuel gas manifold supplying the fuel gas to the individual separators of the laminated body and the fuel gas channel of the individual separators thereof to increase the pressure drop in the fuel gas channel of the separators and reduces, to 10% or lower, the variation of the total pressure drop caused by the separator channel pressure drop and the current collector channel pressure drop.

The solid oxide fuel cell has an advantage in that the gas flow restricting mechanism can be used to increase the separator channel pressure drop to absorb a large variation in the channel pressure drop itself in the fuel electrode current collector and thereby can reduce the variation in the total pressure drop to 10% or lower.

However, the conventional solid oxide fuel cell having the gas flow restricting mechanism such as the orifice has a problem in that enough pressure drop required for uniform supply can be generated by making smaller the restricting portion of the orifice or the like, but in contrast, the restricting portion thereof becomes more difficult to be fabricated with a high precision; and a pressure drop error due to a fabrication error occurs between the gas flow restricting mechanisms and thus the desired uniform supply cannot be achieved.

In addition, there is another problem in that when the cross-sectional area of the restricting portion is formed to have a small diameter such as 1 mm or less, fine foreign particles are gradually accumulated for a long period of use to block the channel; the pressure drop becomes equal to or greater than the original design value, or the difference in the pressure drop occurs between the individual power generation cells; and thus the desired uniform supply cannot be achieved.

In view of this, the Patent Document 1 has proposed another method of increasing the separator channel pressure drop by making smaller the cross-sectional area of the fuel gas channel itself formed in the separator, instead of the gas flow restricting mechanism.

Here, FIG. 8 shows a separator disclosed in the Patent Document 1.

The separator 1 is integrally formed to include: an interconnection section 3 inside of which a fuel gas channel 2a and an oxidant gas channel 2b are formed, and which covers the power generation cell, and to which a compressive load is applied in the lamination direction; an oxidant arm section 4 which starts at the interconnection section 3, extending along an outer periphery thereof to form an L shape, and reaches the diagonal portion 3a, and inside of which an oxidant gas channel 2b is formed; a fuel arm section 5 which starts at the interconnection section 3, extending along an outer periphery thereof to form an L shape symmetrically with respect to the oxidant arm section 4, and reaches the diagonal portion 3b, and inside of which an oxidant gas channel 2a is formed; an oxidant gas manifold 7 provided at the diagonal portion 3a and inside of which an oxidant gas channel 6 communicatively connected in the lamination direction is formed; and a fuel gas manifold 9 provided at the diagonal portion 3b and inside of which an fuel gas channel 8 communicatively connected in the lamination direction is formed.

The solid oxide fuel cell using the separator 1 configured as above has an advantage in that the deflection of the oxidant arm section 4 and the fuel arm section 5 having a flexibility respectively can be used to absorb and reduce the difference between the compressive load applied to the interconnection section 3 and the tightening force for maintaining the sealing performance in the lamination direction in the oxidant gas manifold 7 and the fuel gas manifold 9.

However, as described above, instead of the gas flow restricting mechanism, if the cross-sectional area of the fuel gas channel itself formed in the separator 1 is made smaller, the cross-sectional area of the fuel gas channel in the fuel arm section 5 becomes smaller; as a result, if the oxidant arm section 4 and the fuel arm section 5 have the same external dimension, the rigidity of the fuel arm section 5 becomes relatively higher, and the flexibility thereof becomes relatively lower than that of the oxidant arm section 4.

As a result, a biased deformation occurs in the interconnection section 3 such that the deflection amount increases gradually from the fuel arm section 5 side having a high rigidity to the oxidant arm section 4 side having a low rigidity. For this reason, the variation in the diffusive flow of the fuel gas and the oxidant gas with respect to the entire surface of the power generation cell occurs, and thus the power generation efficiency may decline. Further, the deflection amount occurring in the interconnection section 3 becomes large. As a result, there may occur damage of the power generation cell and an increase in electrical contact resistance due to the biased load.

With that in mind, if the oxidant gas channel of the oxidant arm section 4 is formed to have the same cross-sectional area as that of the fuel gas channel of the fuel arm section 5, for example, when air is used as the oxidant, the flow amount is very large such as 5 to 10 times the amount of fuel gas, and thus the pressure in the oxidant gas channel becomes high. As a result, there is a problem in that a leak may occur in the seal portion of the oxidant gas manifold 7, and thus the improvement is expected.
Patent Document 1: Japanese Patent Application No. 2005-259587

### DISCLOSURE OF THE INVENTION

In view of such circumstances, the present invention has been made, and an object of the present invention is to provide a fuel cell which can enhance uniform supply of a fuel gas to an individual power generation cell as well as can minimize a variation of deformation in an interconnection section.

In order to solve the above problems, the present invention is characterized in that the present invention is a fuel cell configured such that a unit cell including: a power generation cell which is formed in a flat plate shape, and in which a fuel electrode layer is provided on one surface thereof and an oxidant electrode layer is provided on the other surface thereof; a fuel electrode current collector provided on the fuel electrode layer side of the power generation cell and an oxidant electrode current collector provided on the oxidant electrode layer side; and a separator which is provided outside the fuel electrode current collector and the oxidant electrode current collector, and on which a fuel gas channel and an oxidant gas channel supplying a fuel gas or an oxidant gas to the respective fuel electrode current collector or oxidant electrode current collector are formed; is laminated in a plurality of layers and a compressive load is applied between the separators in the lamination direction, the fuel cell characterized in that the separator is integrally formed to include: an interconnection section, inside of which the fuel gas channel and the oxidant gas channel are formed, and which covers the power generation cell, and to which the compressive load is applied; an oxidant arm section which starts at one diagonal portion of the interconnection section, extending along an outer periphery of the interconnection section, and reaches the other diagonal portion thereof, and inside of which the oxidant gas channel is formed; a fuel arm section which starts at the other diagonal portion of the interconnection section, extending along an outer periphery of the interconnection section, and reaches the one diagonal portion thereof, and inside of which the fuel gas channel is formed; an oxidant gas manifold which is provided at the other diagonal portion, and inside of which the oxidant gas channel communicatively connected in the lamination direction is formed; and a fuel gas manifold which is provided at the one diagonal portion, and inside of which the fuel gas channel communicatively connected in the lamination direction is formed, and the fuel gas channel formed on the fuel arm section has a cross-sectional area smaller than the cross-sectional area of the oxidant gas channel formed on the oxidant arm section, as well as the fuel arm section and the oxidant arm section are formed such that both section moduli are substantially the same.

In the fuel cell, it is preferable that each of the fuel arm section and the oxidant arm section is formed to have a uniform cross-sectional area throughout the respective entire length and the difference between both section moduli is 1% or lower.

Further, in the fuel cell, it is preferable that each of the separators is configured such that a plurality of flat plate shaped members are laminated and integrated; and the fuel arm section and the oxidant arm section as well as the fuel gas channel and the oxidant gas channel formed thereon are formed to have a rectangular cross section.

According to the present invention, when there is used the separator integrally formed to include: an interconnection section which covers the power generation cell, and to which the compressive load is applied; an oxidant arm section and a fuel arm section which start at one or the other diagonal portion of the interconnection section, extending along an outer periphery of the interconnection section respectively, and reach the other or the one of diagonal portion thereof; and the oxidant gas manifold and the fuel gas manifold provided at the diagonal portions, since the fuel gas channel formed on the fuel arm section has a cross-sectional area smaller than the cross-sectional area of the oxidant gas channel of the oxidant arm section, by increasing the pressure drop in the fuel gas channel in the separator, about 10% of variation in the amount of fuel flowing to the individual power generation cells caused by the variation of the pressure drop in the fuel electrode current collector can be reduced to 2% or lower, thereby greatly improving the uniform supply of the fuel gas to the individual power generation cells.

In addition, although the cross-sectional area of the fuel gas channel is made relatively smaller, the section moduli of the fuel arm section and the oxidant arm section are set to be substantially the same, and thus the flexibility (rigidity) of both arm sections can be made substantially the same. Therefore, the variation of deformation in the interconnection section can be minimized, thereby preventing the decrease in power generation efficiency due to a variation in the diffusive flow of the fuel gas and the oxidant gas, or damage of a power generation cell and an increase in electrical contact resistance due to a variation in the deflection amount thereof.

In this case, in general, the cross-sectional area of the fuel gas channel and the oxidant gas channel is about several square millimeters. Therefore, in order to control, in the design phase, the pressure drop in the fuel gas channel in the individual separators and minimize the variation of deformation in the interconnection section, as the invention set forth in claim 2, it is preferable that the fuel arm section and the oxidant arm section are formed to have a uniform cross-sectional area throughout the entire length respectively.

It should be noted that it is defined in claim 1 that the fuel arm section and the oxidant arm section are formed such that both section moduli are substantially the same, which means that, allowing for fabrication errors, both section moduli are set such that the deflection amount of the interconnection section covering the power generation cell with a diameter of 120 to 150 mmφ or longitudinal and lateral dimensions of 120 to 150 mm is 50 μm or less.

In order to satisfy such a condition, for example, if the cross-sectional area is formed to be uniform throughout the respective entire length as the invention set forth in claim 2, the final difference in both section moduli between the fuel arm section and the oxidant arm section should be 1% or less regardless of the fabrication error.

Further, the fuel gas channel and the oxidant gas channel starting at the fuel gas manifold or the oxidant gas manifold, passing through the fuel arm section or the oxidant arm section and reaching the interconnection section need to be formed in the separator. Therefore, as the invention set forth in claim 3, if the configuration is made such that a plurality of flat plate shaped members are laminated and integrated, both channels with a rectangular cross section can be formed simply by forming a strip-shaped opening in a predetermined flat plate shaped member and laminating each other.

Since it is relatively easy to fabricate the strip-shaped opening with a very high precision, an excellent uniform supply can be achieved by adjusting, to a desired value, the cross-sectional area of the fuel arm section and the oxidant arm section.

### BRIEF DESCRIPTION OF THE DRAWINGS

FIG. 1 is an entire front view showing an embodiment of a fuel cell in accordance with the present invention;

FIG. 2 is a longitudinal sectional view showing a unit cell in FIG. 1;

FIG. 3 is a partially enlarged view of the portion A in FIG. 2;

FIG. 4 is a plan view showing a shape of the separator in FIG. 1;

FIG. 5A is a sectional view of the air arm section in FIG. 4;

FIG. 5B is a sectional view of the fuel arm section in FIG. 4;

FIG. 6 is a plan view showing a deflection distribution curve in an interconnection section of the separator in FIG. 4;

FIG. 7 is a plan view showing a deflection distribution curve in the interconnection section of the separator as a comparative example with respect to FIG. 6; and

FIG. 8 is a plan view showing the shape of a conventional separator.

### DESCRIPTION OF SYMBOLS

10 Unit cell
11 Solid electrolyte
12 Fuel electrode layer
13 Air electrode layer (oxidant electrode layer)
14 Power generation cell
15 Fuel electrode current collector
16 Air electrode current collector (oxidant electrode current collector)
17 Fuel gas channel
18 Air channel (oxidant gas channel)
19 Separator
20 Interconnection section
20a One diagonal portion
20b The other diagonal portion
21 Air arm section (oxidant arm section)
22 Fuel arm section
23 Air manifold (oxidant gas manifold)
24 Fuel gas manifold
25, 26 Gasket
29 Plummet
30 Fuel cell

### BEST MODE FOR CARRYING OUT THE INVENTION

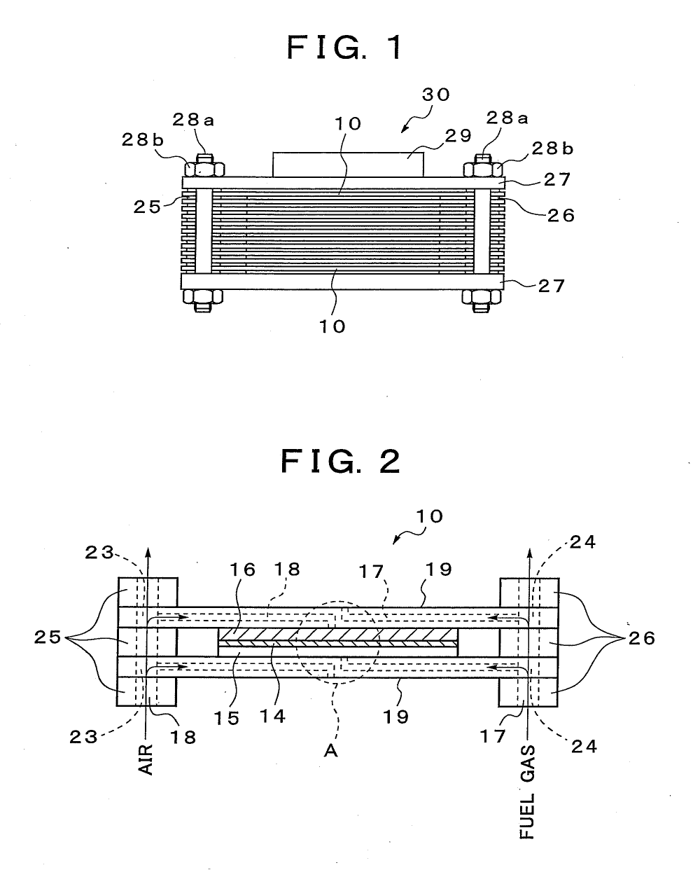

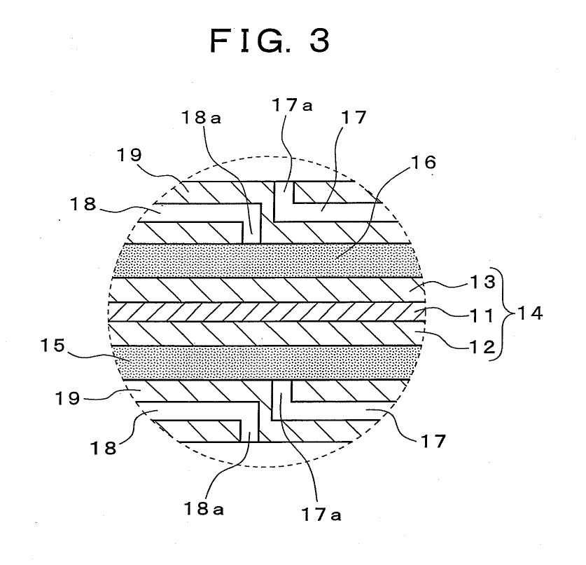

FIGS. 1 to 6 show an embodiment of the fuel cell in accordance with the present invention, and reference numeral 10 denotes a unit cell constituting the fuel cell 30.

The unit cell 10 is schematically configured to include a power generation cell 14 on which a fuel electrode layer 12 is provided on one surface of a solid electrolyte layer 11 and an air electrode layer (oxidant electrode layer) 13 is provided on the other surface thereof; a fuel electrode current collector 15 provided on a fuel electrode layer 12 side of the power generation cell 14 and an air electrode current collector (oxidant electrode current collector) 16 provided on an air electrode layer 13 side thereof; and separators 19, one of which is provided outside the fuel electrode current collector 15 and in which a fuel gas channel 17 supplying a fuel gas to the fuel electrode current collector 15 is formed, and the other one of which is provided outside the air electrode current collector 16 and in which an air channel (oxidant gas channel) 18 supplying air (oxidant gas) to the oxidant electrode current collector 16 is formed.

Here, the solid electrolyte layer 11 is made of yttria-stabilized zirconia (YSZ) or the like; the fuel electrode layer 12 is made of a metal such as Ni or a cermet such as Ni-YSZ; the air electrode layer 13 is made of LaMnO₃, LaCoO₃, or the like. On the one hand, the fuel electrode current collector 15 is made of a sponge-like porous sintered metal plate such as Ni; and on the other hand, the air electrode current collector 16 is made of a sponge-like porous sintered metal plate such as Ag. The current collectors 15 and 16 have a current collecting function, a gas transport function, a gas diffusion function, a cushion function, a thermal expansion difference absorption function, and the like respectively.

The separator 19 has a function of electrically connecting the power generation cells 14 to each other and of supplying the fuel gas and air to the power generation cells 14.

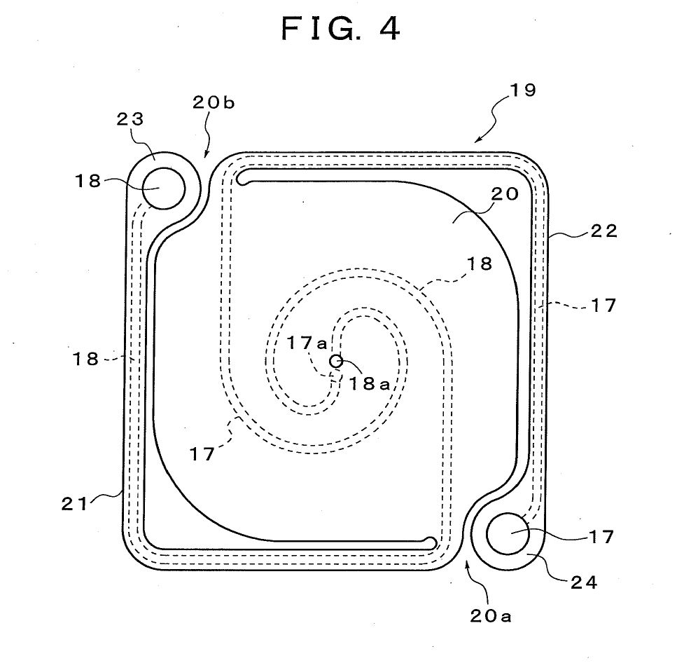

As shown in FIG. 4, the separator 19 is integrally formed to include an interconnection section 20 which is formed in an area larger than the power generation cell 14 to cover the power generation cell 14; an air arm section (oxidant arm section) 21 which starts at one diagonal portion 20a of the interconnection section 20 extending along an outer periphery of the interconnection section 20 to form an L shape and reaches the other diagonal portion 20b; a fuel arm section 22 which starts at one diagonal portion 20b of the interconnection section 20 extending along an outer periphery of the interconnection section 20 to form an L shape and reaches the other diagonal portion 20a; an air manifold (oxidant gas manifold) 23 provided at the diagonal portion 20b side; and a fuel gas manifold 24 provided at the diagonal portion 20a side.

The fuel gas channel 17 starts at the fuel gas manifold 24, passing through the fuel arm section 22, and reaches the interconnection section 20; and the air channel 18 starts at the air manifold 23, passing through the air arm section 21, and reaches the interconnection section 20.

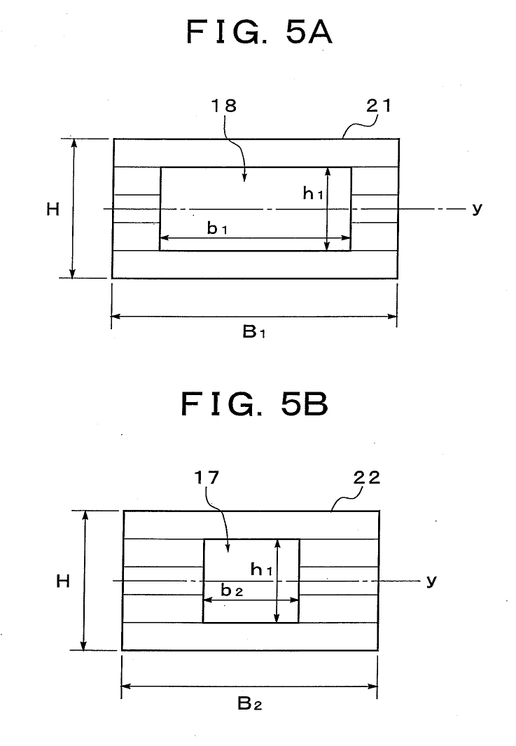

Here, the separator 19 is formed in a plate shape with a thickness of 2 to 3 mm, by punching a plurality of (five according to the present embodiment as shown in FIGS. 5A and 5B) substantially square stainless-steel plates (flat plate shaped member) and integrally coupling the individual plates to each other.

As shown in FIGS. 2 and 4, the air channel 18 formed on the air manifold 23 and the fuel gas channel 17 formed on the fuel gas manifold 24 are formed to penetrate therethrough in the plate thickness direction respectively.

The intermediate three of the five stainless-steel plates are punched to form the air arm section 21, the fuel arm section 22, and the air channel 18 and the fuel gas channel 17 in the interconnection section 20 (see FIGS. 5A and 5B). The air channel 18 and the fuel gas channel 17 are formed to start at the diagonal portions 20a and 20b in the interconnection section 20 and extend spirally toward the center portion without crossing each other.

Here, the fuel arm section 22 and the fuel gas channel 17 have a uniform cross-sectional area throughout the entire length, and the air arm section 21 and the air channel 18 also have a uniform cross-sectional area throughout the entire length. As shown in FIGS. 5A and 5B, the cross-sectional area (h₁×b₂) of the fuel gas channel 17 formed in the fuel arm section 22 is smaller than the cross-sectional area (h₁×b₁) of the air channel 18 formed in the air arm section 21. For example, h₁=1.5 mm, b₁=3.0 mm, b₂=1.0 mm.

The fuel arm section 22 and the air arm section 21 are formed so that the difference in both section moduli Z is 1% or lower.

More specifically, the section modulus Z of the air arm section 21 is (B₁H³-b₁h₁³)/6H, the section modulus Z of the fuel arm section 22 is (B₂H³-b₂h₁³)/6H. Therefore, in order to make the neutral axis y and the height H common to both, it is preferable to design as follows:

B₁H³-b₁h₁³=B₂H³-b₂h₁³

The design is made such that the final difference in both section moduli Z is 1% or lower, allowing for round-off errors in the calculations and fabrication errors.

On the other hand, the distal end of the air channel 18 is communicatively connected to a spout 18a formed at the center of the lower surface of the interconnection section 20 in the figure; and the distal end of the fuel channel 17 is communicatively connected to the spout 17a formed at the center of the upper surface of the interconnection section 20 in the figure.

In the figure, separators 19 are placed adjacently in upper and lower positions respectively and a ring-shaped insulative gasket 25 having the air channel 18 therein is placed between the air manifolds 23; and a ring-shaped insulative gasket 26 having the fuel gas channel 17 therein is placed between the fuel gas manifolds 24 respectively.

The fuel cell 30 is configured such that a plurality of unit cells 10 configured as above are laminated, the peripheral edge portions of the clamping plates 27 provided in upper and lower positions thereof respectively are tightened with bolts 28a and nuts 28b so as to be integrated in a closely appressed state between the air manifold 23 and the gasket 25, and the fuel gas manifold 24 and the gasket 26 respectively. An opening is formed at the center portion of the upper clamping plate 27, where a plummet 29 is provided to apply a load between the upper and lower separators 19 in the lamination direction.

In the fuel cell 30, the fuel electrode current collector 15 and the air electrode current collector 16 made of a porous metal respectively are elastically deformed to some extent and are pressure-bonded and sandwiched with some elastic force between the upper and lower separators 19. In the corner portions thereof, the air channel 18 continuing in the lamination direction is formed inside the air manifold 23 and the gasket 25; and the fuel gas channel 17 continuing in the lamination direction is formed inside the fuel gas manifold 24 and the gasket 26.

During operation, air and fuel gases are supplied from outside to the manifolds 23 and 24 respectively. The respective gases pass through the air channel 18 and the fuel gas channel 17 formed in the respective separators 19 and reach the respective spouts 18a and 17a thereof. Then, respective gases are emitted to the fuel electrode current collector 15 side and the air electrode current collector 16 side, being diffusively transported thereinside and are distributed and introduced to the respective electrode surfaces of the individual power generation cells 14.

According to the above configured fuel cell 30, the pressure drop in the fuel gas channel 17 formed in the fuel arm section 22 can be increased to reduce about 10% of variation in the amount of fuel flowing to the individual power generation cells 14, particularly caused by the variation of the pressure drop in the individual fuel electrode current collectors 15, to 2% or lower, thereby greatly improving the uniform supply of the fuel gas to the individual power generation cells 14.

In addition, although the cross-sectional area of the fuel gas channel 17 is made relatively smaller, the difference between the section modulus Z of the fuel arm section 22 and the section modulus Z of the air arm section 21 is set to be 1% or lower, and thus the flexibility (rigidity) of both arm sections 21 and 22 can be made substantially the same. As a result, the variation and the deflection amount in interconnection section 20 can be minimized, thereby preventing the decrease in power generation efficiency due to a variation in the diffusive flow of fuel gas and oxidant gas, or the damage of a power generation cell and the increase in electrical contact resistance due to a variation in the deflection amount thereof.

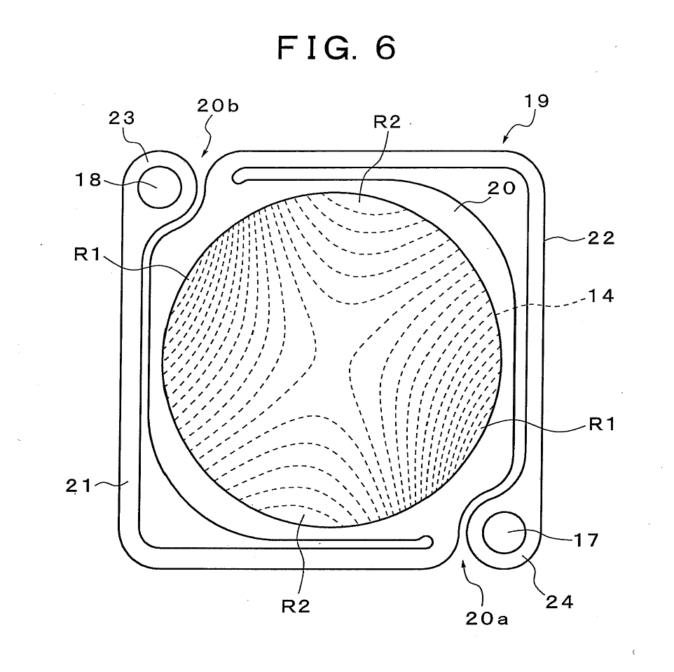

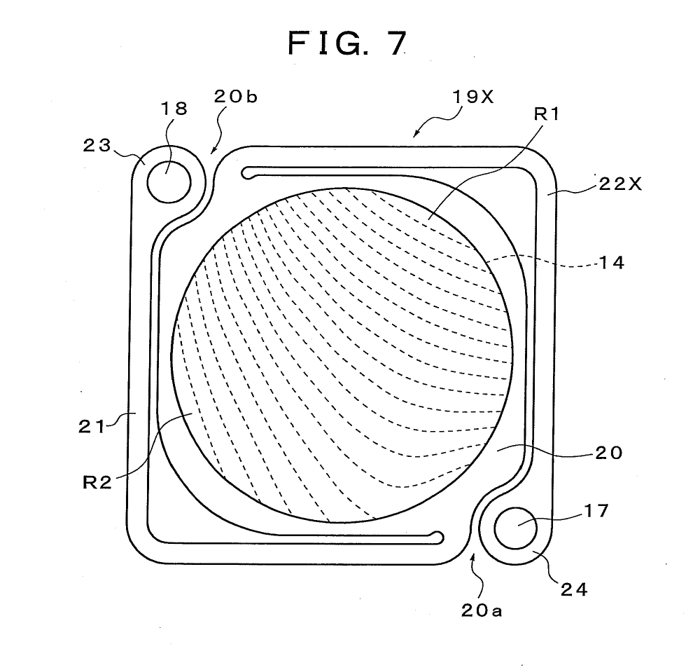

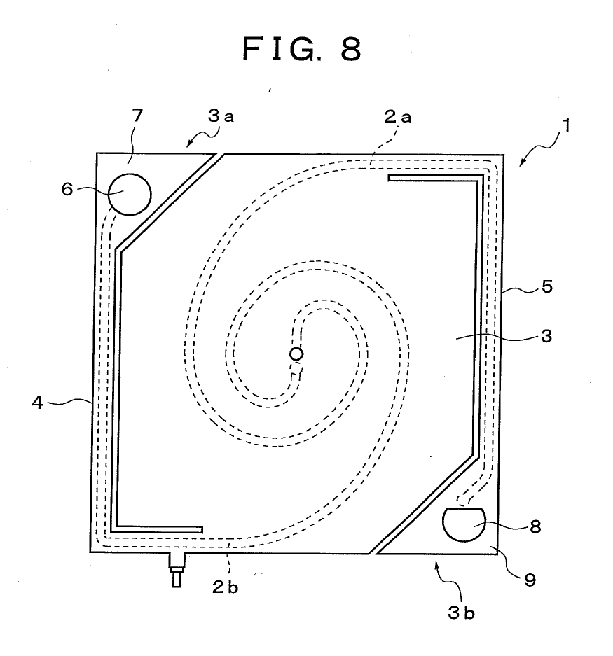

In order to confirm the above effect, the present inventors analyzed the deflection amount obtained by applying a load to the interconnection section 20 in the lamination direction using a separator 19 (FIG. 6) having the same shape as the separator having a size large enough for the interconnection section 20 to cover the power generation cell 14 with an external diameter of 120 mmφ shown in FIGS. 4, 5A, and 5B, and a separator 19X (FIG. 7) having a fuel arm section 22X in which the fuel gas channel 17 has the same cross sectional shape as that of the separator 19 and the arm section has the same external size as that of the air arm section 21.

As a result, in the separator 19X shown in FIG. 7, the rigidity of the fuel arm section 22X was relatively higher than that of the air arm section 21. As a result, as understood from the deflection distribution curve shown by dotted lines in the figure, a biased deformation occurred in the interconnection section 20 where the power generation cells 14 were placed, such that the deflection amount increased gradually from a region shown by R1 in the figure to a region shown by R2 in the figure as well as the deflection amount occurring in the interconnection section 20 became large amounting to 106 μm.

In contrast to this, according to the separator 19 in accordance with the present invention shown in FIG. 6, as understood from the deflection distribution curve shown by dotted lines in the figure, a symmetric distribution of the deformation amount occurred in the interconnection section 20 where the power generation cells 14 were placed, such that the regions having a large deflection amount shown by R1 in the figure appeared symmetrically to the regions having a small deflection amount shown by R2 in the figure respectively as well as the entire deflection amount was 43 μm, in other words, the entire deflection amount was confirmed to be able to be reduced to 50 μm or lower.

According to the fuel cell, the separator 19 is made of a plurality of (five in the figure) flat plate shaped members, as well as the fuel arm section 22 and the fuel gas channel 17 are formed to have a rectangular cross section and have a uniform cross-sectional area throughout the entire length respectively. Therefore, the pressure drop in the fuel gas channel 17 of the individual separator 19 can be easily adjusted in the design phase, and the variation of deformation in the interconnection section 20 can be minimized.

The fuel gas channel 17 having each side of about 1 to 1.5 mm can be formed with a high precision simply by forming a strip-shaped opening in the three flat plate shaped members located in the intermediate portion and laminating them to each other. Accordingly, an excellent uniform supply and rigidity can be easily achieved by adjusting the cross-sectional area of the fuel arm section 22 to a desired value.

### INDUSTRIAL APPLICABILITY

As described above, the present invention can provide a fuel cell which can enhance the uniform supply of a fuel gas to the individual power generation cells as well as can minimize the variation of deformation in the interconnection section.

1. A fuel cell configured such that a unit cell comprising: a power generation cell which is formed in a flat plate shape, and in which a fuel electrode layer is provided on one surface thereof and an oxidant electrode layer is provided on the other surface thereof; a fuel electrode current collector provided on the fuel electrode layer side of the power generation cell and an oxidant electrode current collector provided on the oxidant electrode layer side; and a separator which is provided outside the fuel electrode current collector and the oxidant electrode current collector, and in which a fuel gas channel and an oxidant gas channel supplying a fuel gas or an oxidant gas to the respective fuel electrode current collector or oxidant electrode current collector are formed; is laminated in a plurality of layers and a compressive load is applied between the separators in the lamination direction,
the fuel cell characterized in that the separator is integrally formed to include: an interconnection section, inside of which the fuel gas channel and the oxidant gas channel are formed, and which covers the power generation cell, and to which the compressive load is applied; an oxidant arm section which starts at one diagonal portion of the interconnection section, extending along an outer periphery of the interconnection section, and reaches the other diagonal portion thereof, and inside of which the oxidant gas channel is formed; a fuel arm section which starts at the other diagonal portion of the interconnection section, extending along an outer periphery of the interconnection section, and reaches the one diagonal portion thereof, and inside of which the fuel gas channel is formed; an oxidant gas manifold which is provided at the other diagonal portion, and inside of which the oxidant gas channel communicatively connected in the lamination direction is formed; and a fuel gas manifold which is provided at the one diagonal portion, and inside of which the fuel gas channel communicatively connected in the lamination direction is formed, and
the fuel gas channel formed on the fuel arm section has a cross-sectional area smaller than the cross-sectional area of the oxidant gas channel formed on the oxidant arm section, as well as the fuel arm section and the oxidant arm section are formed such that both section moduli are substantially the same.

2. The fuel cell according to claim 1, wherein each of the fuel arm section and the oxidant arm section has a uniform cross-sectional area throughout the respective entire length and the difference between both section moduli is 1% or lower.

3. The fuel cell according to claim 1, wherein each of the separators is configured such that a plurality of flat plate shaped members are laminated and integrated; and the fuel arm section and the oxidant arm section as well as the fuel gas channel and the oxidant gas channel formed-thereon are formed to have a rectangular cross section.
